(19) United States
(12) Patent Application Publication
(10) Pub. No.: US 2016/0063524 A1
(43) Pub. Date: Mar. 3, 2016

(54) ONLINE SURVEY RESULTS PRESENTATION TOOLS AND TECHNIQUES

(71) Applicant: SURVEYMONKEY INC., Palo Alto, CA (US)

(72) Inventors: Joshua Hornik, Burlingame, CA (US); Fang Zhao, Fremont, CA (US); John Michael Anderson, Redwood City, CA (US); Bradley Phillips Olcott, San Francisco, CA (US)

(21) Appl. No.: 14/473,397

(22) Filed: Aug. 29, 2014

(51) Int. Cl. G06Q 30/02

(52) U.S. Cl. CPC G06Q 30/0203

(57) ABSTRACT

A computer-controlled method includes an electronic device receiving online survey results from a question of an online survey and an electronic display visually presenting to a user the online survey results over a total period of time. The visually presenting can include visually presenting a representation of the number of online survey results that corresponds with each answer in connection with a discrete period of time within the total period of time. Each result can be visually identified by a corresponding identifier.

### TECHNICAL FIELD

The disclosed technology generally pertains to various types of systems and methods for presenting, e.g., visually, results of online surveys that are administered by way of electronic devices such as personal computers and mobile electronic devices, e.g., smartphones and tablet computing devices.

### BACKGROUND

Online surveys have become increasingly valuable to individuals, companies, and virtually all types of organizations by enabling such entities to quickly and efficiently obtain various types of information from any number of target populations. Such information may include customer preferences, feedback on products and/or services, and customer service-related information, for example. Companies may incorporate such information in making various business and/or strategic or otherwise tactical decisions. Additionally, the continued prevalence of mobile electronic devices, such as smartphones and tablet computing devices, in today's society provides individuals, business entities, and other groups with even greater access to virtually every type of target populations for electronic surveys and other information-gathering mechanisms. Indeed, millions of people around the world use the Internet or other networks on a regular—often daily—basis, both at home and at their workplace. Accordingly, there remains a need for further improvements in presenting online survey results from data that is collected in association with online surveys that are taken by online survey participants.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 is a flowchart illustrating an example of a computer-controlled method in accordance with certain embodiments of the disclosed technology.

FIG. 4 illustrates a first example of an online survey results presentation technique in accordance with certain embodiments of the disclosed technology.

FIG. 5 illustrates a second example of an online survey results presentation technique in accordance with certain embodiments of the disclosed technology.

FIG. 6 illustrates a first interaction of a third example of an online survey results presentation technique in accordance with certain embodiments of the disclosed technology.

FIG. 7 illustrates a second interaction of the third example of an online survey results presentation technique illustrated by FIG. 6.

FIG. 8 illustrates a third interaction of the third example of an online survey results presentation technique illustrated by FIGS. 6 and 7.

FIG. 9 illustrates a fourth example of an online survey results presentation technique in accordance with certain embodiments of the disclosed technology.

### DETAILED DESCRIPTION

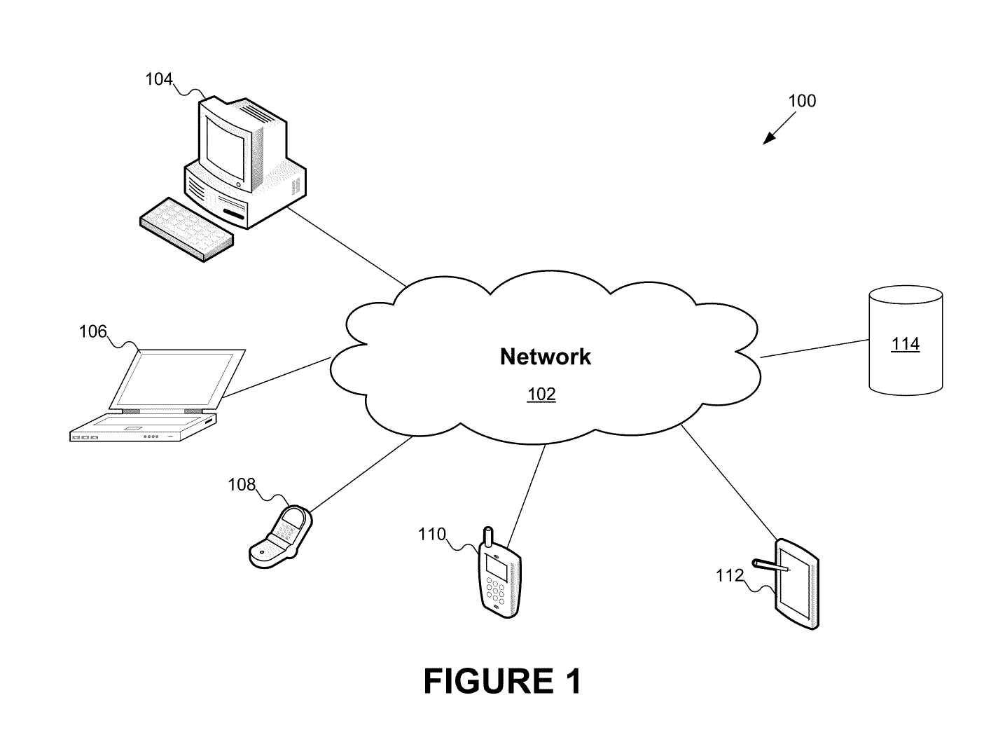

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

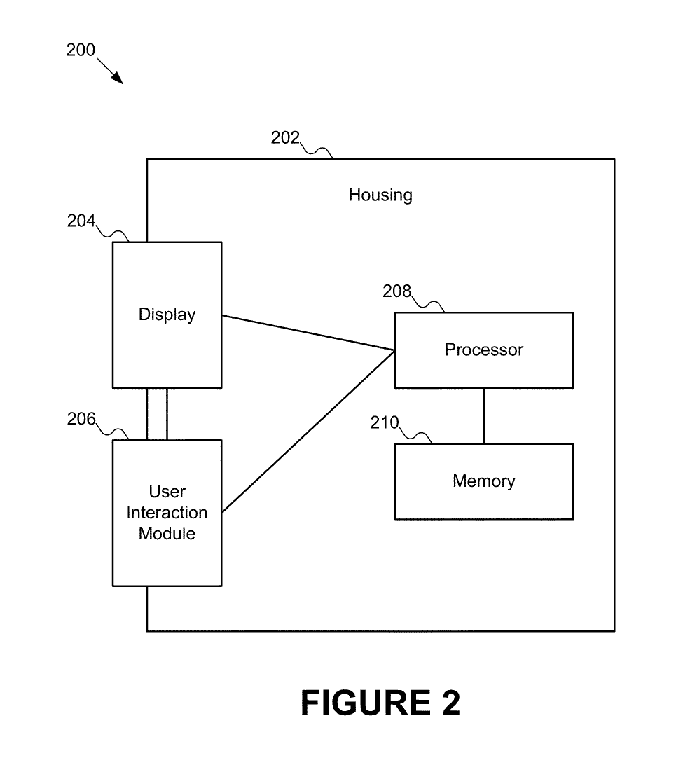

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

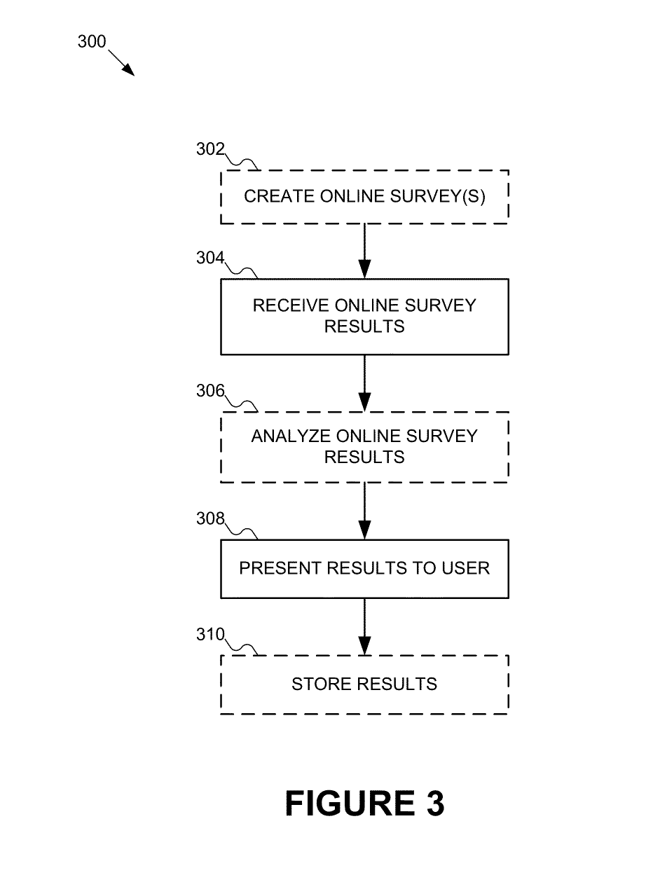

FIG. 3 is a flowchart illustrating an example of a computer-controlled method 300 in accordance with certain embodiments of the disclosed technology.

At 302, at least one online survey is created. In certain embodiments, one or more surveys that were previously created [by the same user or other users] may be used in addition to or in place of one or more newly-created surveys.

At 304, results of the online survey(s) are received. For example, raw data may be received directly from survey takers that have at least partially taken the survey(s) that were created and/or selected at 302.

At 306, the online survey results may be optionally analyzed using any suitable analysis technique(s).

At 308, any or all of the online survey results that were received at 304 [and, in some instances, analyzed at 306] are presented, e.g., visually by way of a monitor or other suitable display, to a user using any of the various techniques described herein, or any combination thereof, for example.

At 310, the online survey results may be stored. The results may be stored locally (e.g., by the user's electronic device), remotely (e.g., by an external server), or both locally and remotely.

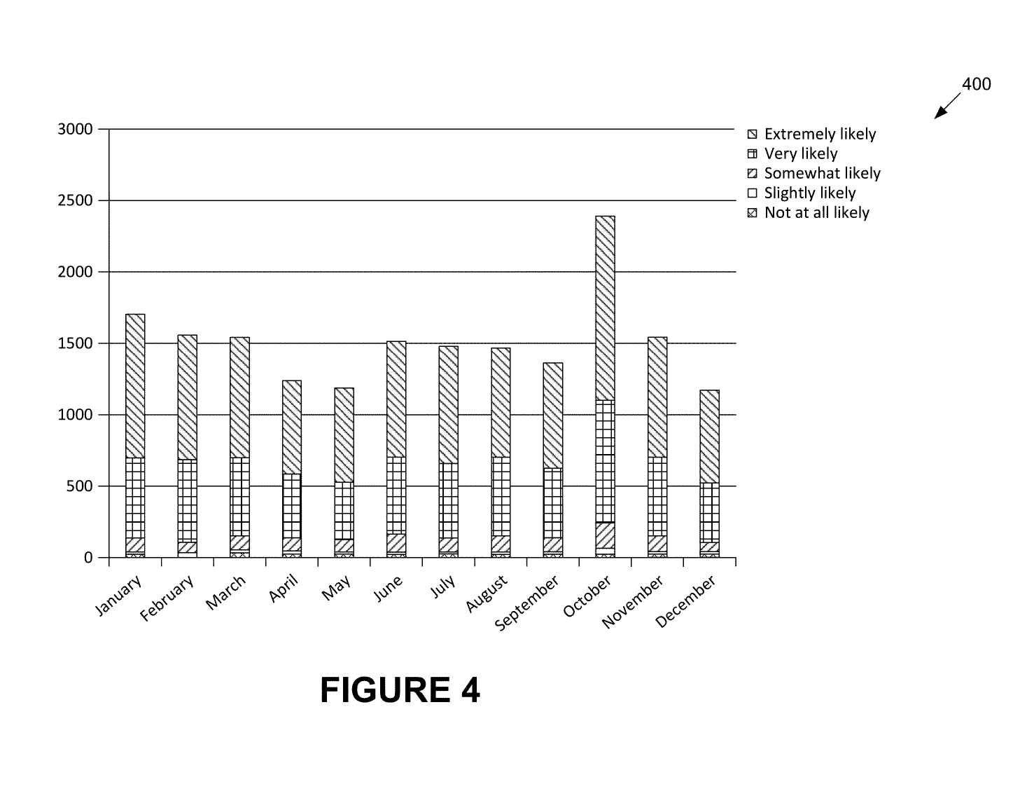

FIG. 4 illustrates a first example 400 of an online survey results presentation technique in accordance with certain embodiments of the disclosed technology. In the example 400, a bar graph is the basis for providing a visual representation of certain online survey results that are broken down by a certain period of time. Here, the data is broken down by month such that there is presented a bar for each month that provides a visual representation of the online survey results for each month, e.g., “Extremely likely.”

By simply looking at the visual presentation 400, a user may quickly and easily discern how many online survey responses were received for each month [vis-à-vis other months in the displayed period] as well as a relative breakdown of the responses for each month. In the example, the online survey results include five answers to a particular question: “Extremely likely,” “Very likely,” “Somewhat likely,” “Slightly likely,” and “Not at all likely.” Each answer is assigned a particular pattern such that the visual representations thereof can be readily distinguished by a viewer, particularly vis-à-vis each other.

Thus, the viewer may quickly and easily see data trends over the total period of time, e.g., a year, by paying attention to all of the monthly breakdowns as a single group. That is, the visual presentation 400 may enable the viewer to discern one or more data trends over the entirety of the displayed period of time. In the example 400, a user may advantageously appreciate fluctuations with regard to the online survey results on a monthly basis over the course of an entire year, both in terms of total responses and breakdowns thereof.

In certain embodiments, the visual presentation 400 may represent the same timezone as that of a default timezone as established by [or for] the user, regardless of the actual location of the user (or device used by the user). For example, if the user's default time zone is Pacific Standard Time (e.g., because he or she is from or based on the West Coast), the visual presentation 400 may display the information in Pacific Standard Time, even if the user is currently traveling on the East Coast, for example.

In certain embodiments, the visual presentation 400 may take into account potential limitations of the device being used by the user such as how much data a browser on the device can show, for example. Any of a number of default settings may be used to take such potential limitations into account. Implementation of at least one of such default settings may advantageously result in potentially large and long-running survey result displays being displayed in a friendly manner.

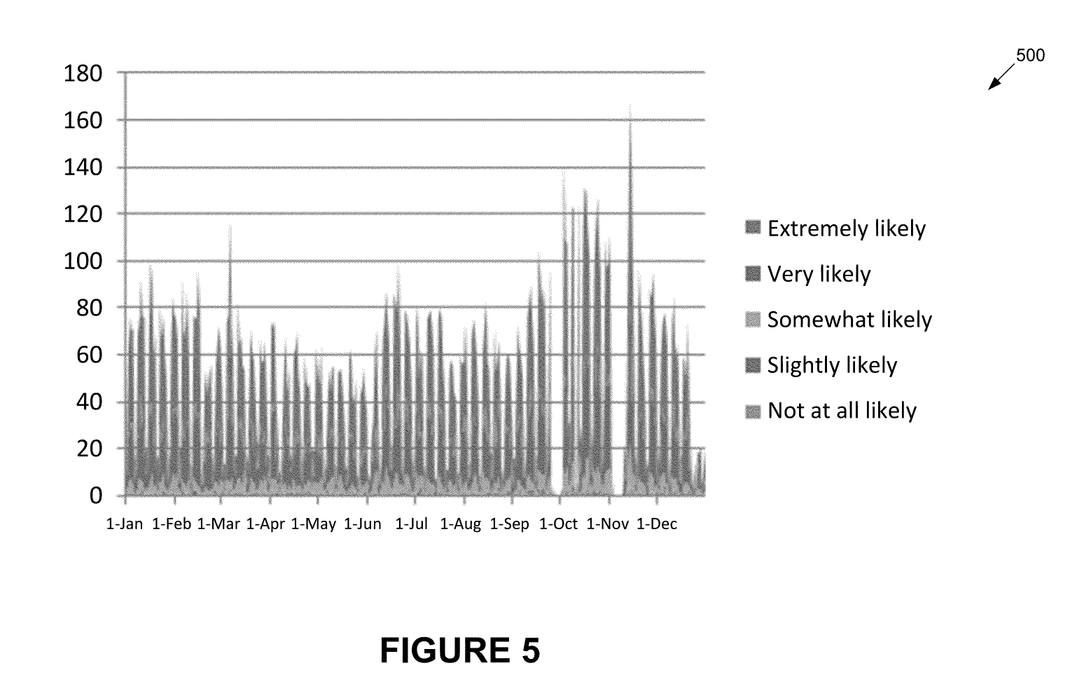

FIG. 5 illustrates a second example 500 of an online survey results presentation technique in accordance with certain embodiments of the disclosed technology. This second example 500 is similar to the first example 400 illustrated by FIG. 4 in that the displayed period of time is a year and the online survey results include the same five answers to a particular question (“Extremely likely,” “Very likely,” “Somewhat likely,” “Slightly likely,” and “Not at all likely”). Whereas the first example 400 provides a breakdown of the data by month, however, the breakdown in the second example 500 is by day. That is, whereas there are twelve “bars” in the first example 400, there are essentially 365 “bars” in the second example 500. This allows the viewer to quickly and easily see data trends at a significantly greater level of granularity (approximately thirty times greater) than in the first example 400.

While the first and second examples 400 and 500 visually present online survey results broken down by month and day, respectively, one of ordinary skill in the art will appreciate that such data may be visually presented broken down by virtually any discrete period of time, e.g., quarter, week, hour, and even minute or second (which may depend on the size of the entire period of time that is presented, the size of the displayable area, or both). In certain embodiments, a user may designate a custom period of time such as period of three weeks or two months, for example.

In certain examples, the total period of time and/or breakdowns displayed may be automatically determined based on one or more measured or detected parameters. For example, in situations where all of the online survey results span a period of less than a day, the default display may be hourly breakdowns. In situations where the online survey results span a period of less than 30 days, 6 months, 3 years, or 10 years, for example, the default display may be daily, weekly, monthly, or quarterly breakdowns, respectively. In situations where the online survey results span a period of greater than 10 years, the default display may be yearly breakdowns, and so on.

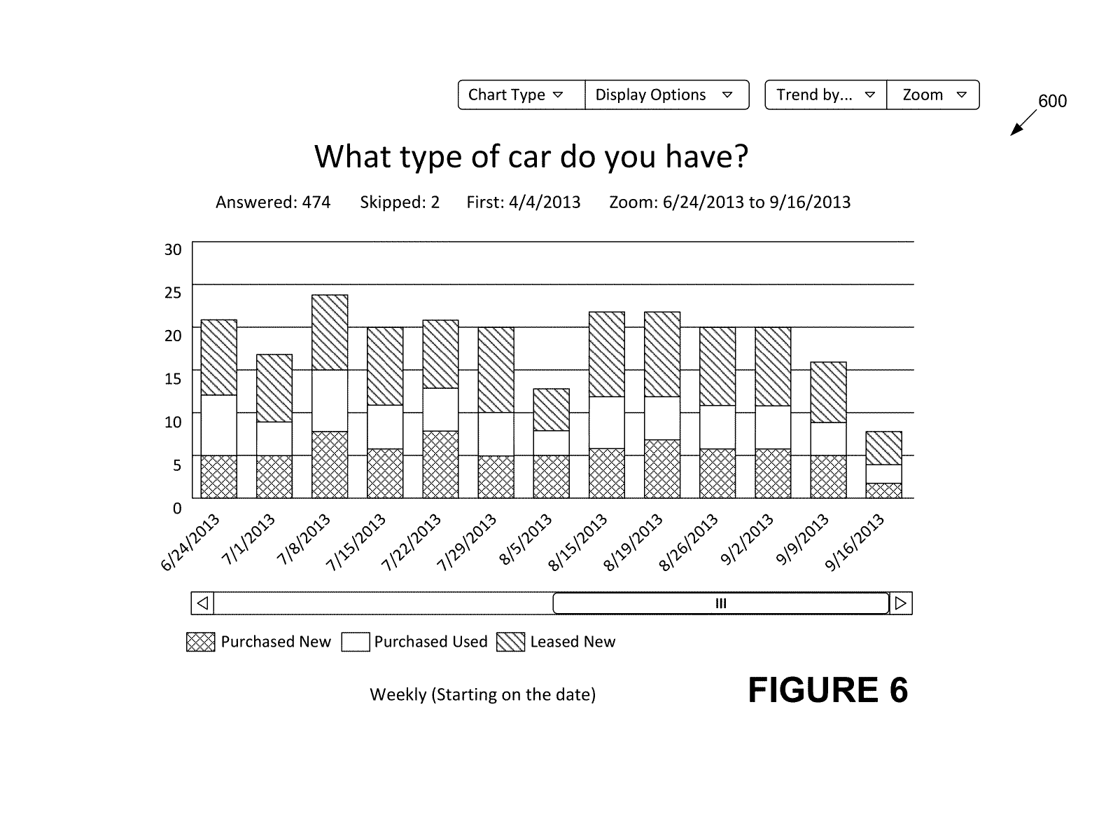

FIG. 6 illustrates a first interaction 600 of a third example of an online survey results presentation technique in accordance with certain embodiments of the disclosed technology. In the third example, a bar graph is the basis for providing a visual representation of certain online survey results that are broken down by week such that there is presented a bar for each week that provides a visual representation of three answers to a particular question: “Purchased New,” “Purchased Used,” and “Leased New.” As with the first and second examples 400 and 500 illustrated by FIGS. 4 and 5, respectively, each answer is assigned a particular pattern such that the visual representations thereof can be readily distinguished by a viewer, particularly vis-à-vis each other.

As with the first example 400, a viewer may quickly and easily see data trends in the displayed results in the third example 600 over an entire year by paying attention to all of the [weekly] breakdowns as a single group. That is, the visual presentation 600 may enable the viewer to discern one or more data trends over the entirety of the displayed period of time and appreciate fluctuations with regard to the online survey results on a weekly basis over the course of the year, both in terms of total responses and breakdowns thereof.

In the example, only a portion (referred to herein as “zoom portion”) of the entire period (e.g., year) of presented results is currently visible. Here, only the results for the week periods beginning with Jun. 24, 2013 and ending with Sep. 16, 2013 are visible. In the example, a scroll bar may be used by a viewer such that the viewer may see the remaining (e.g., “non-zoom”) portions of the entire time period.

In certain embodiments, a default zoom portion may be the entire displayed period. If the entire displayed period is a year, for example, the default zoom portion may be 365 days. In alternative embodiments, the default zoom portion may be less than the entire period of displayed results, e.g., the final 30 days of survey results in situations where the entire period of time is greater than 30 days (such as a year, for example). A default zoom portion may be automatically determined based on one or more measured or detected parameters.

The third example 600 also provides additional information, including [but not limited to] the number of answers received for the corresponding question, the number of skips (e.g., no response to the question received), and the date of the first received answer to the question.

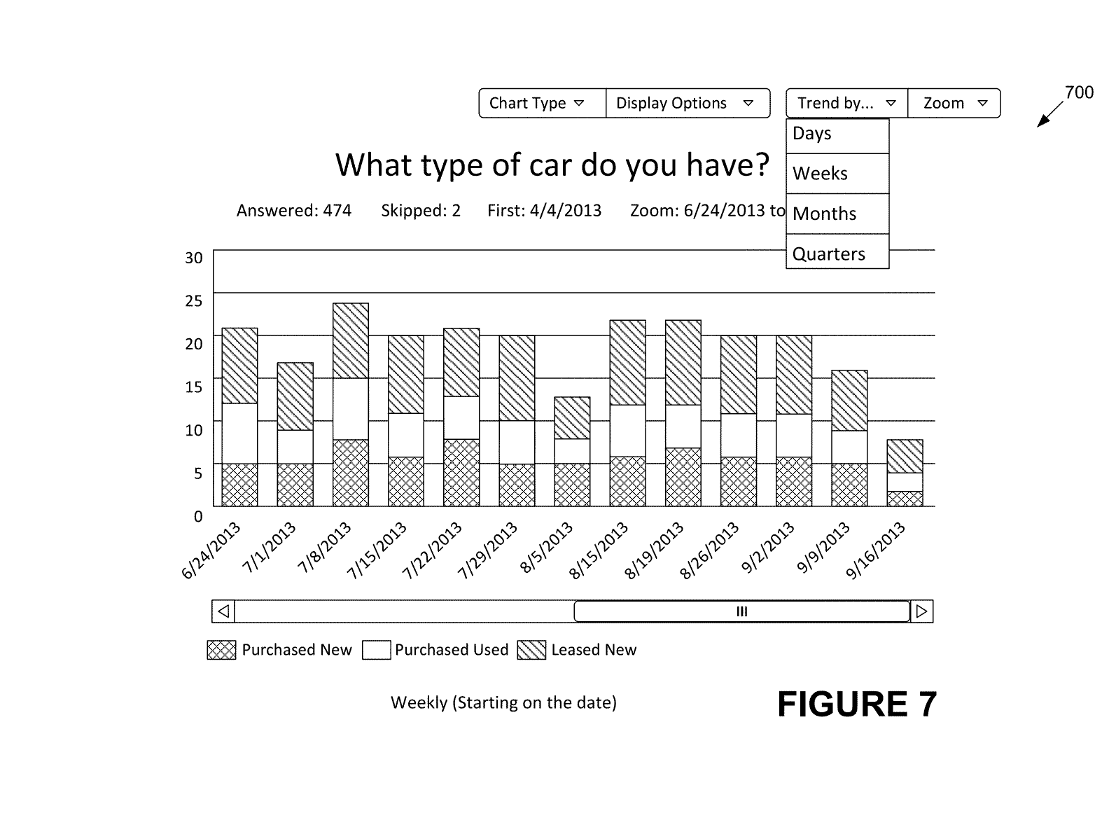

FIG. 7 illustrates a second interaction 700 of the third example of an online survey results presentation technique illustrated by FIG. 6. In the example 700, a viewer or other user has selected the “Trend by . . . ” control. Responsive thereto, the viewer or other user is presented with multiple trending options; here, the options are “Days,” “Weeks,” “Months,” and “Quarters.”

The trending options presented to the viewer/user may depend on the currently-displayed breakdown of online survey results. For example, if the results are currently presented as daily breakdowns, the trending options provided may include 7, 30, or 90 days. If the results are currently presented as weekly breakdowns, the trending options provided may include 30, 90, or 365 days, for example. If the results are currently presented as monthly breakdowns, the trending options provided may include 90 or 365 days or 3 years, for example. If the results are currently presented as quarterly breakdowns, the trending options provided may include 365 days or 3 years, for example, and so on.

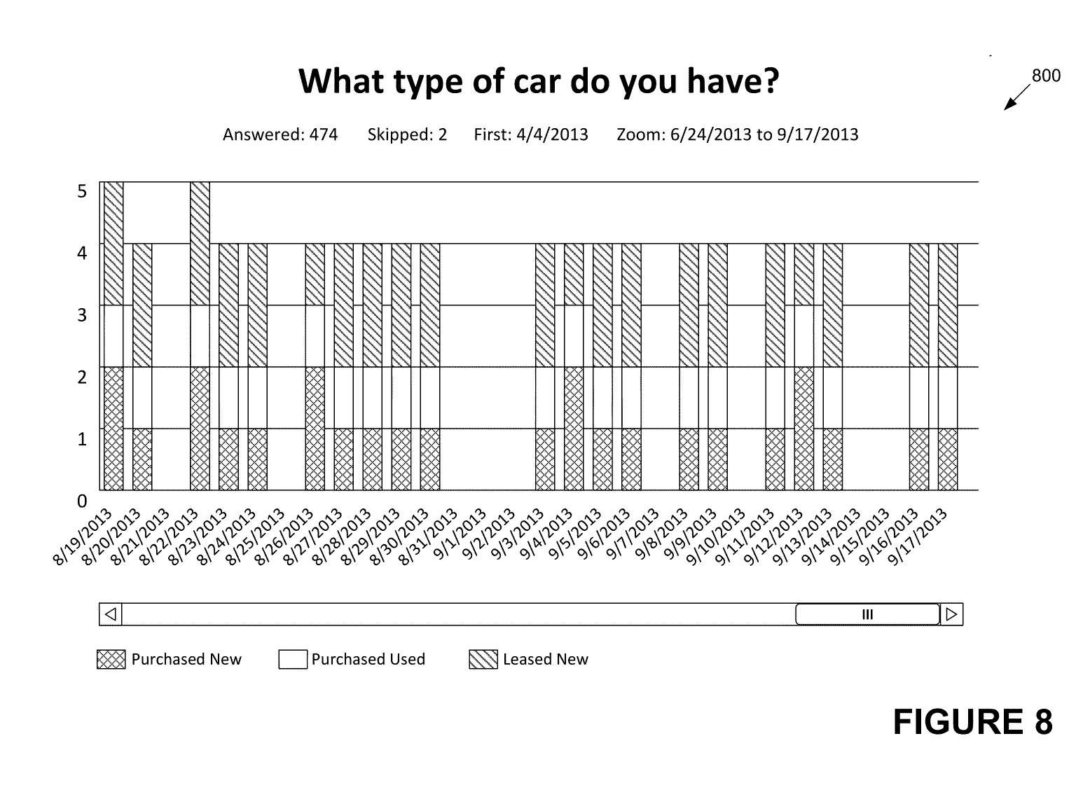

FIG. 8 illustrates a third interaction 800 of the third example of an online survey results presentation technique illustrated by FIGS. 6 and 7. Responsive to the viewer/user selecting “Days” from the “Trend by . . . ” control in the second interaction 700, the third interaction includes a visual presenting of the online survey results between Jun. 24, 2013 and Sep. 16, 2013 on a day-by-day (i.e., daily) basis. Thus, the visual presentation 800 may enable the viewer to discern one or more data trends over the entirety of the zoom period and appreciate fluctuations with regard to the online survey results on a daily basis over the course of the zoom period, both in terms of total responses and breakdowns thereof. The viewer can also quickly identify days that may not have any results, such as the days beginning with August 31 and ending with September 2, for example. As with the third example 600, a scroll bar may be used by a viewer such that the viewer may see the remaining (e.g., “non-zoom”) portions of the entire time period.

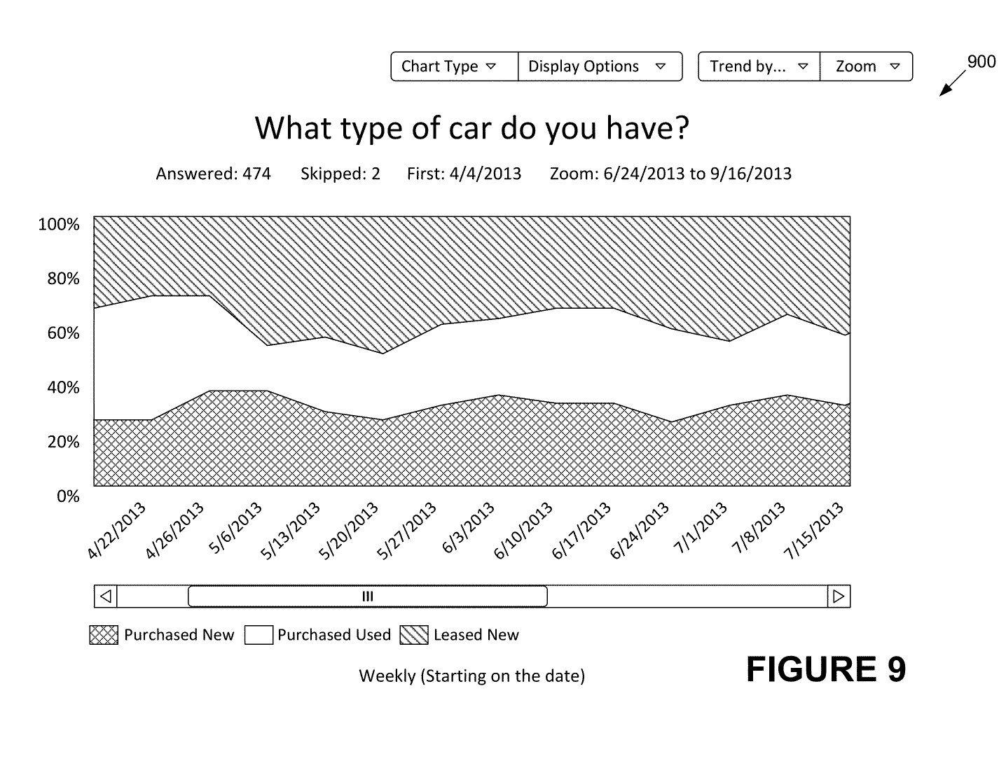

FIG. 9 illustrates a fourth example 900 of an online survey results presentation technique in accordance with certain embodiments of the disclosed technology. In the example, the displayed chart presents a percentage of the total responses for the entire time period rather than an absolute number. This advantageously smooths out the differences in response volume over time so a viewer can get right to the changes in the answers. The viewer/user may use a “Chart Type” control menu to change between bar charts, line charts, and area charts, for example. Here, a weekly chart displayed in percentages instead of absolute numbers has been changed to an area chart.

Implementations of the disclosed technology may enable a user to determine any of a number of things such as whether customers' satisfaction with a certain product changed over time, whether changes made have led to improvement in employee satisfaction, and how reviews for a certain year's event compare to the prior year's event, for example. Users can see clear trends in online survey data and also tell how many people answered a certain question each week, and instantly see any trends as to how the answers are changing.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A computer-controlled method, comprising:
an electronic device receiving a plurality of online survey results from at least a first question of a first online survey, the first question having a corresponding first plurality of answers; and
an electronic display visually presenting to a user the plurality of online survey results over a total period of time, wherein the visually presenting includes:
visually presenting a representation of the number of the plurality of online survey results that corresponds with each of the plurality of answers in connection with one of a plurality of discrete periods of time within the total period of time; and
visually identifying each result by a corresponding identifier.

2. The computer-controlled method of claim 1, wherein the identifying comprises visually associating a different pattern with each of the plurality of answers.

3. The computer-controlled method of claim 1, wherein the identifying comprises visually associating a different color with each of the plurality of answers.

4. The computer-controlled method of claim 1, wherein the total period of time is selected from a group consisting of: one day, one week, one month, one quarter, and one year.

5. The computer-controlled method of claim 1, wherein the plurality of discrete periods is selected from a group consisting of: hours, days, weeks, months, quarters, and years.

6. The computer-controlled method of claim 1, wherein the visually presenting includes visually presenting a representation of the number of the plurality of online survey results that corresponds with each of the plurality of answers in connection with one of a plurality of discrete periods of time within a sub-portion of the total period of time.

7. The computer-controlled method of claim 6, further comprising, responsive to the user interacting with a scroll bar, visually presenting a representation of the number of the plurality of online survey results that corresponds with each of the plurality of answers in connection with one of a plurality of discrete periods of time at least partially outside of the sub-portion of the total period of time.

8. The computer-controlled method of claim 6, wherein visually presenting the representation of the number of the plurality of online survey results that corresponds with each of the plurality of answers in connection with one of a plurality of discrete periods of time within the sub-portion of the total period of time is responsive to the user selecting the sub-portion.

9. The computer-controlled method of claim 1, further comprising the user selecting the plurality of discrete periods of time within the total period of time.

10. The computer-controlled method of claim 9, further comprising the user selecting the plurality of discrete periods of time within the total period of time from a group consisting of: hours, days, weeks, months, quarters, and years.

12. The computer-controlled method of claim 10, further comprising visually presenting to the user a “trend by” control to enable the user to select the plurality of discrete periods of time within the total period of time.

13. The computer-controlled method of claim 1, wherein the electronic device includes the electronic display.

14. The computer-controlled method of claim 1, further comprising storing the visual presentation of the plurality of online survey results over the total period of time.

15. The computer-controlled method of claim 1, wherein the electronic device is a mobile device.

16. The computer-controlled method of claim 15, wherein the electronic device is a smartphone.

17. The computer-controlled method of claim 1, wherein the electronic display is part of a mobile device.

18. The computer-controlled method of claim 17, wherein the mobile device is a smartphone.

19. The computer-controlled method of claim 1, wherein the visually presenting further includes determining a default timezone specific to the user.

20. The computer-controlled method of claim 19, wherein the visually presenting further includes visually presenting the representation based on the default timezone, regardless of an actual geographic location of the electronic device, an actual geographic location of the electronic display, or both.

21. The computer-controlled method of claim 1, wherein the visually presenting further includes taking into account at least one default pertaining to a limitation of the electronic display.

22. The computer-controlled method of claim 21, wherein the limitation of the electronic display specifies a maximum amount of information that be may displayed by the electronic display.
